(19) United States
(12) Patent Application Publication
(10) Pub. No.: US 2002/0158827 A1
(43) Pub. Date: Oct. 31, 2002

(54) Method for utilization of a gyroscopic or inertial device as a user interface mechanism for headmounted displays and body worn computers

(76) Inventor: Dennis A. Zimmerman, Bridgewater, VA (US)

Correspondence Address: Welsh & Katz, 22nd Floor, 120 South Riverside Plaza, Chicago, IL, 60606, US

(21) Appl. No.: 09/915,000

(22) PCT Filed: May 16, 2001
(86) PCT No.: PCT/US01/15816

(51) Int. Cl. G09G 3/36

(52) U.S. Cl. 345/88

(57) ABSTRACT

A method of using a compute in a hands free environment, including the use of a gyroscopic sensor, in association with a mouse driver, to manipulate a computer curser across a computer screen is provided. The method utilizes either voice recognition software, in association with a hierarchal command set, which allows simple commands for routine computer mouse functions, or a body mounted paddle or switch device which allows simple body movements to perform click and drag functions of a mouse. The invention is particularly useful in association with body mounted computers having head mounted screens, as the method overcomes the problems of selecting computer functions while away from a desk or laptop computer.

The present application claims the benefit of the early filing date of U.S. Provisional Application No. 60/204,582, filed May 16, 2000.

### FIELD OF THE INVENTION

The present invention concerns a gyroscopic or inertial device for moving a cursor across a computer screen, voice recognition software or a separate click producing device for activating mouse functions, and a method for using the device. More particularly, the present invention concerns the use of a computer in a generally hands-free environment by using a gyroscopically based cursor moving device in combination with a “click” production element to perform the function of a mouse in hand.

### BACKGROUND OF THE INVENTION

Body worn computers, as well as sole purpose body worn devices, have become increasingly available over the past several years. In a typical configuration, a head or body mounted display is used as the visual interface for the user. Unfortunately, state of the art in body worn computers remains restricted due to the current options available to the user to interact or provide direct input to the computing device. Standard options for user input typically consist of some sort of pseudo-mouse or pointing device, such as a touchscreen or Hula Pointer. These solutions require the user to interact not only visually with the computing device but also with their hands (clicking, selecting, etc.) This renders the overall mobile computing configuration inappropriate for hands free applications. Other commercially available interface solutions, such as the TWIDDLER and BAT are essentially a specialized hand held keyboard, but use of these devices requires a certain degree of learning and a large degree of manual dexterity for successful operation. While more esoteric pointing devices, such as laser retina scanners and the like exist on the outer fringes of the art, the cost for such devices is prohibitively high.

Currently, the most prevalent user interface solution in the hands-free area is device control by voice recognition.

Voice recognition (VR) remains a functional but imperfect and somewhat lacking solution to the hands free problem. VR has been demonstrated to be unreliable in a high ambient-noise environment, and is best used in conjunction with a specially scripted and limited hierarchal menu structure in order to successfully navigate throughout the application “screens.”

Typically, VR must be used in concert with one of the traditional input devices in order to move the pointing arrow around the screen and to make menu selections in the conventional “mouse click” or double click manner associated with most computer software programs.

It would be desirable to have a means in which to move a cursor about a computer screen in a hands-free manner and provide a hands free mode of operation to select and activate computer options.

It would further be desirable to have a means in which to move a cursor and activate options which would be inexpensive to manufacture, easy and intuitive in use, and accurate.

### SUMMARY OF THE INVENTION

In accordance with the present invention, a method of manipulating a cursor and activating computer functions includes the steps of providing a computer, a computer screen associated therewith, and a gyroscopic sensor for mounting to the body of the user. The gyroscopic sensor is reactive to body movements. The method further includes the steps of providing a mouse driver in association with the gyroscopic sensor, such that movements of the gyroscopic device cause a concomitant movement of a cursor on the computer screen. The method further includes providing a microphone and voice recognition software associated with the microphone, the voice recognition software having a driver for activating computer functions.

In a preferred embodiment of the present invention, the voice recognition software further includes providing hierarchal commands such that selection of computer functions is associated with simple words. The method includes causing the movement of the computer cursor by moving the body part associated with the gyroscopic device, in a predetermined manner, and causing the execution of computer functions by selecting an icon or menu item on the screen and reciting predetermined words associated with the desired actions.

Preferably, the gyroscopic device of the present invention is worn about the head and permits small movements of the head to control the direction and speed of the cursor.

In the preferred embodiment, a small gyroscope or inertial sensor is included in the basic configuration of a body worn computer and/or a head mounted display. In this manner certain natural movements of the body will guide the pointing arrow, or cursor, on a computer screen to the desired location on the screen. This provides a new level of body worn computing ergonomics and a generally hands free device operating environment.

In a preferred embodiment of the invention, a sensor, such as a gyroscopic device, is embedded in a head-mounted display and connected to the mouse driver that resides on the associated body worn computer (or any other computer to which the device may be applied). As a result of very minor movement of the head in either a horizontal or vertical axis, the cursor can be maneuvered to any area on the display with a smooth and very accurate virtual appearance. By combining the cursor functionality of the sensor with the limited voice control, a virtual “click and drag” environment is created in a generally hands free environment.

In one embodiment, if it is desired to move an icon or file to another location on the computer screen, the user places the cursor over the object to be selected by making subtle movements of the body part associated with the sensor. Once centered over the desired object, a voice command, such as “DRAG,” causes the selection of the object, similar to a single click on a conventional mouse. Movement of the object is then accomplished by reorienting the position of the head until the object has been moved to the desired location. Subsequently, a voice command, such as “CLICK,” de-activates the previous command, and the object is de-selected. Restating the command “CLICK” would act much the same as a “double click” on a conventional mouse causes the document or application to be opened. A variation on the mouse voice command such as “CLICKRIGHT” would serve as a partial to the advanced functionality of the powerful right mouse button on a conventional mouse in a Windows® environment. It is to be understood that the device and method of the present invention can be used in association with all point and click based systems including MAC OS, Linux, OS2, DOS and other operating systems without departing from the novel scope of the present invention.

In a preferred embodiment, the gyroscopic sensor would be tethered to the unit containing the computer processor by means of a wire or cable. It is noted that persons having skill in the art will recognize that the new “Bluetooth” wireless transmission protocol, and other wireless technologies, known to persons having skill in the art, such as wireless Ethernet 802.3 technology and others, can be used to embed the gyroscopic sensor without a hardwired connection between the sensor and the computer processor.

In a further embodiment in either a hard wired or wireless environment, the gyroscopic sensor can be incorporated into a wrist band and worn on the wrist. Subtle movements of the hand and wrist would then guide the cursor around the display screen. A small lever, for example, in the form of a small handle, can be attached to the wrist band on a pivot on the underside of the band, extending from the wrist towards the palm of the hand. An extension of approximately 25% of the length of the palm would be a preferred length. It is to be understood that any percentage of the length of the palm, desired by the user, can be accommodated without departing from the novel scope of the present invention. Depression of the lever with the fingertips would activate the switch and fully emulate the functionality of the classic mouse. While this is not entirely a hands free embodiment, the embodiment dispenses with the need for voice integration and truly allows for the classic “click and drag” and “double click” functionality that has become recognized in modem computer operation.

It will be understood by persons having skill in the art that placement of the gyroscopic sensor, whether hard wired or wireless, is not restricted to placement or operation solely on the head or wrist. The sensor may be placed anywhere on the body that affords a small range of movement and the potential to activate a switch, without departing from the novel scope of the present invention.

A more detailed explanation of the invention is provided in the following description and claims and is illustrated in the accompanying drawings.

### BRIEF DESCRIPTION OF THE DRAWINGS

FIG. 1 is a pictorial representation of a method of use of a user interface mechanism of the present invention.

FIG. 2 is a pictorial representation of the user interface mechanism of FIG. 1.

FIG. 3 is a pictorial representation of another embodiment of a method of use of the user interface mechanism of the present invention.

FIG. 4 is a pictorial representation of the user interface mechanism of FIG. 2.

FIG. 5 is a pictorial representation of another embodiment of a user interface mechanism of the present invention.

### DETAILED DESCRIPTION

While the present invention is susceptible of embodiment in various forms, there is shown in the drawings a number of presently preferred embodiments that are discussed in greater detail hereafter. It should be understood that the present disclosure is to be considered as an exemplification of the present invention, and is not intended to limit the invention to the specific embodiments illustrated. It should be further understood that the title of this section of this application (“Detailed Description”) relates to a requirement of the United States Patent Office, and should not be found to limit the subject matter disclosed herein.

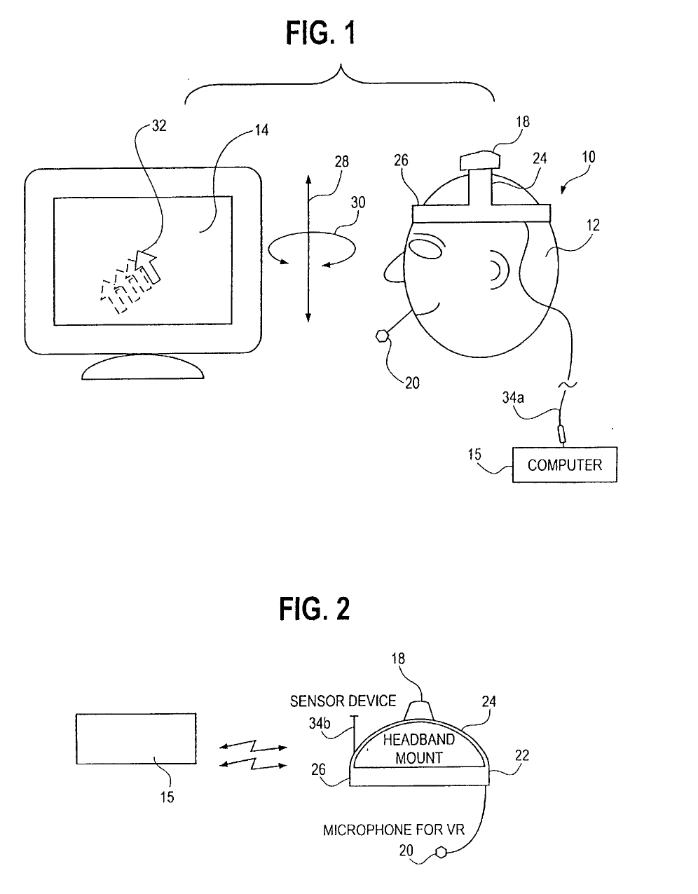

Referring to FIG. 1, a user interface device 10 is shown, worn by a user 12, in association with a desk top style computer screen 14, and a desktop style computer 15. User interface device 10 includes a sensor device 18, which in a preferred embodiment is a gyroscopic device, such as the commercially available gyroscopic device manufactured by GyRations Company of Saratoga, Calif. It will be understood by those having skill in the art that any suitable type of gyroscopic device, either electronic, mechanical or optical can be used in the present application without departing from the novel scope of the present invention. Further, it will be understood that other types of inertial sensor device can be substituted for the gyroscopic device of the present invention without departing from the novel scope of the present invention.

In the embodiment of the invention shown in FIG. 1, user interface device 10 is further equipped with a microphone 20, through which voice commands may be given. Persons having skill in the art will recognize that voice recognition software, running on the computer associated with the present invention, will allow the user 12 to speak commands into microphone 20, which commands will be executed by the computer. In a preferred embodiment of the present invention, the voice recognition software includes a specially scripted and limited hierarchal menu structure, such that frequently used simple commands can be quickly and easily adapted for use by any person using the device and method. For example, words which are associated with the common action of a mouse may be adapted by the voice recognition software as commands to perform the action spoken. The word “CLICK” may be programmed such that its use will cause the action associated with a single press of a “left mouse button,” in a Windows®, UNIX or other operating system environment. Other common actions include “DRAG,” which cause the action of a continuous depression of the left mouse button while moving the mouse. The term “DRAG” would be used in association with appropriate movements of sensor device 18 to, for example, move a folder, icon or other object from one area of the screen 14 to another. A further variation of typical mouse action includes the use of the command “CLICKRIGHT” to cause the computer to perform the action of a right mouse click in a Windows®, UNIX or other operating system environment.

It will be understood by persons having skill in the art that other means to effect desired actions on screen, in association with sensor device 18, may be used without departing from the novel scope of the present invention. The present invention also contemplates a device that can emulate the actions of the buttons of a mouse device via clicking by foot movement (stepping) or by manipulation of a wrist mounted device by the user's fingers.

The sensor device 18 and microphone 20, in the present embodiment, are attached together (FIG. 2) in a headband 22 style mount. The headband 22 can be formed of a resilient, flexible material 24 on which sensor 18 may be mounted and from which microphone 20 may depend. Further, the interface device 10 may include a band 26, preferably of a cloth material having elastic properties, for maintaining headband 22 on the user's head. It will be understood by persons having skill in the art, that the headband 22, for example, may be constructed in the form of a “hard hat” for use in dangerous locations (such as construction sites), or in the form of a hat with a brim for use in sunny areas, or in the form of a bat having thermal properties, for use in areas of inclement weather. Other configurations of headgear can also be constructed by persons having skill in the art without departing from the novel scope of the present invention.

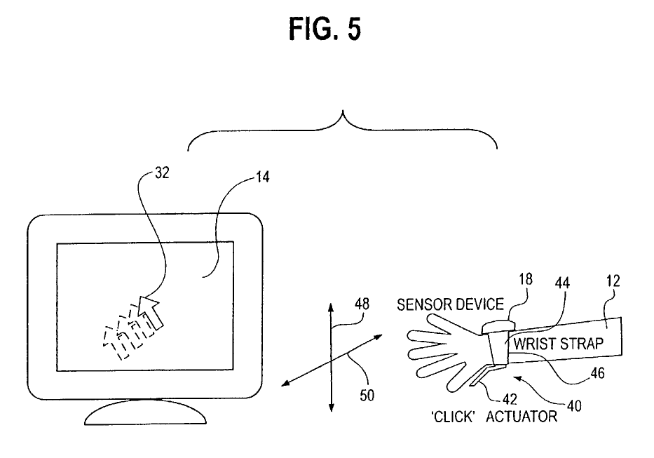

Referring back to FIG. 1, it will be understood by persons having skill in the art that the mounting location of sensor 18 is not critical to the operation of the interface device 10 and method of the present invention. As long as the sensor 18 can operate in the vertical plane 28 and horizontal plane 30, a cursor 32 may be caused to move by simple movements of the head. The driver software, loaded into the associated computer, can be configured to compensate for the location of sensor 18 once its placement is established. It will be understood by persons having skill in the art that the sensor 18 may be placed in any location which will allow free, three dimensional movements, such as on the wrist of the user (FIG. 5), without departing from the novel scope of the present invention.

In operation, upward and downward movement of the user's head causes the cursor 12 to move upwardly and downwardly on the screen 14, respectively. Similarly, left and right movement of the user's head cause left and right movements on the screen, respectively. It will be understood, that movements of the head which combine an up or down movement with a left or right movement, will cause a respective diagonal movement by the cursor 32. When properly aligned, it will appear to user 12 that the movement of cursor 32 follows where the user looks on the display screen 14. It is to be understood, however, that an excessive or exaggerated head movement will not cause the cursor 32 to move any further than the limits of the screen. In a preferred embodiment, excessive or exaggerated head movements are used to re-center, or align the cursor 32 on screen 14. It is to be understood that this “re-centering” procedure is often necessary because the action of looking away from the screen will cause the cursor to be moved in such a manner as to cause its disengagement from its correlation with the sensor 18.

It will be seen that in FIG. 1, the user interface system 10 is operably connected to the associated computer 15 by a cable 34a. It will be understood, by persons having skill in the art, that any known manner of hard wire connection cable, including USB, PS2, serial interface, SCSI interface, parallel port or other, may be used without departing from the novel scope of the present invention.

The associated computer 15 may be any suitable commercially available computer, such as IBM-compatible personal computer, Apple (Macintosh) computer or the like. Further, it is to be understood that computer 15 may also be of unusual types and custom made varieties, such as for example, computers which may be worn on the person of the user and personal digital assistance of all varieties. As shown in FIG. 2, user interface system 10 may be operably connected to the computer 15 by means of the plurality of wireless systems known to persons having skill in the art. A representative antenna 34b is shown to illustrate that the method of communications between interface 10 and its associated computer 15 is by wireless method. However, it will be understood that any method of wireless communications, including infrared, RF, Bluetooth® or other suitable technology, may be used without departing from the novel scope of the present invention.

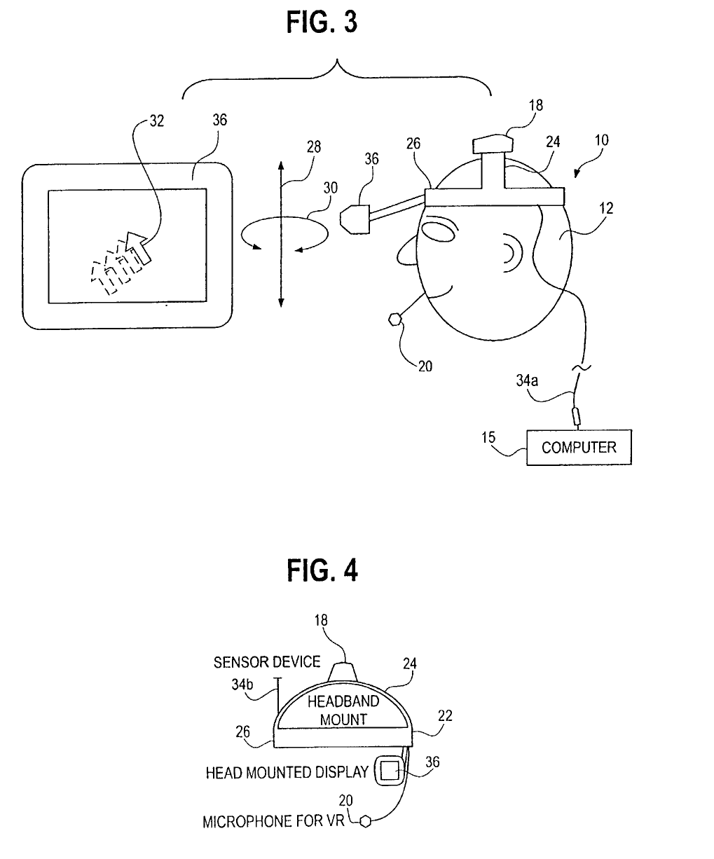

Referring now to FIG. 3, another embodiment of user interface 10 of the present invention is shown. In FIG. 3, a head mounted display 36 is included in addition to the sensor 18 and the microphone 20. The user operation in this embodiment is generally similar to the manner of use described in the previous embodiments. However, because the computer screen 36 of the present embodiment moves along with the head movements of the user 12, the cursor 32 will appear to remain steady as the display screen 36 moves along the user's head. Note, however, that the cursor 32 will move relative to the screen. The speed of the cursor may be adjusted so that the distance moved by the user's head causes the cursor 32 to move by the same distance. In this case, the cursor 32 would appear to remain in a fixed position relative to the room in which the user resides. In this manner, user 12 will become accustomed to moving the screen so as to position it in relation to cursor 32. Programmable cursor speed adjustments will effect how steady cursor 32 appears to be with respect to screen 36.

FIG. 3 illustrates that the cable 34a is used with a hard wire interface 10 to the associated computer 15. Persons having skill in the art will understand that current hardware limitations may necessitate that the head mount display 36 be hardwired to the computer. It is to be understood, however, that the use of wireless technology for head mounted displays is contemplated in the present invention, as indicated by the illustration of a representative antenna 34b in FIG. 4.

In the use of a user interface 10 having a head mounted display, the actions of “Click” and “Drag” may be accomplished as described above, with respect to the user interface used in association with a desk top computer configuration.

Referring now to FIG. 5, it can be seen that a user interface 40 may be worn on the user's wrist in association with a desk top style computer screen 14, and a desktop style computer (not shown). It will be understood by persons having skill in the act, that a wrist worn device can be used with a head mounted display, without departing from the novel scope of the present invention. User interface device 40 includes a sensor device 18 of the type previously described.

In this embodiment, user interface device 40 is further equipped with a click actuating paddle 42, through which actions akin to the actions accomplished by the clicking of a mouse button may be accomplished. The device of FIG. 5 is illustrative of what can be described as a real point and click system. In its use with a desk top computer, the user 12 would move an arm, wrist, leg, foot, or other flexible body part to position the cursor on the display screen 14. The “Click” and “Drag” actions, as previously described, are accomplished by either squeezing or pressing the actuating paddle 42. It is to be understood that the actuating paddle 42 or an equivalent structure may be attached or may be a separate mechanical actuator. It will be understood, by persons having skill in the art, that other mechanical actuators such as foot switches or blow tubes may be used without departing from the novel scope of the present invention.

In FIG. 5, sensor device 18 and actuating paddle 42 are attached together in a wristband 44 style mount. Wristband 44 can be formed of a resilient, flexible material 46 on which sensor 18 may be mounted and from which actuating paddle 42 may depend. The wristband 44 is preferably constructed of a cloth having elastic properties for maintaining the wristband comfortably on the user's wrist, but any suitable material may be used.

It will be understood, by persons having skill in the art, that the mounting location of sensor 18 on wristband 44 is not critical to the operation of the device and method of the present invention. As long as the sensor 18 can operate in the vertical plane 48 and horizontal plane 50, the cursor 32 may be moved by simple movements of the arm or wrist. The driver software, loaded into the associated computer, can be configured to compensate for the location of sensor 18 once its placement is established.

In the use of sensor 18, the user 12 moves his wrist or arm up to cause the cursor 32 to rise of the screen. Downward movement of the wrist or arm similarly causes the cursor 32 to move lower on the screen. Leftward and rightward movement of the cursor follow accordingly. It will be understood, that movements of the wrist or arm which combine and up or down movement with a left or right movement will cause a respective diagonal move by the cursor. User 12 may then effect actions on the computer by movements of the wrist or arm in association with the use of actuation paddle 42. It will be understood, by persons having skill in the art, that the present embodiment of the sensor 18 on a wrist band 44 may be used in association with a microphone and voice recognition software (and associated drivers) as described above, without departing from the novel scope of the present invention.

Although illustrative embodiments of the invention have been shown and described, it is to be understood that various modifications and substitutions may be made by those skilled in the art without departing from the novel spirit and scope of the invention.

What is claimed is:

1. A method of manipulating a cursor and activating computer functions, comprising the steps of:
providing a computer and a computer screen associated therewith;
providing a gyroscopic sensor for mounting to the body of the user, said sensor being reactive to body movements;
providing a mouse driver in associate with said gyroscope, such that movements of said gyroscope cause a concomitant movement of a cursor on said computer screen;
providing a microphone;
providing voice recognition software, associated with said microphone, said voice recognition software having a driver for activating computer functions;
providing hierarchal commands in said voice recognition software such that selection of computer functions arc associated with simple words; and
causing the movement of said cursor by moving the body part associated with said gyroscope, in a predetermined manner, and causing the execution of computer functions by selecting an icon or menu item on said screen and reciting predetermined words associated with the desired actions.

2. The method of claim 1, wherein said body part is the head.

3. The method of claim 1, wherein said body part is the wrist.

4. The method of claim 2, including the step of providing a body mounted view screen.
